(19) United States
(12) Patent Application Publication
(10) Pub. No.: US 2024/0407446 A1
(43) Pub. Date: Dec. 12, 2024

(54) HEATING ASSEMBLY FOR AEROSOL-GENERATING DEVICE

(71) Applicant: Philip Morris Products S.A., Neuchatel (CH)

(72) Inventor: Wei ZHANG, Huizhou (CN)

(73) Assignee: Philip Morris Products S.A., Neuchatel (CH)

(21) Appl. No.: 18/702,016

(22) PCT Filed: Oct. 25, 2021
(86) PCT No.: PCT/CN2021/126197

§ 371 Date: Apr. 17, 2024

(51) Int. Cl. A24F 40/46; A24F 40/51; A24F 40/70

(52) U.S. Cl. CPC A24F 40/46; A24F 40/51; A24F 40/70

(57) ABSTRACT

A heating assembly for an aerosol-generating device is provided, the heating assembly including: a first substrate layer, the first substrate layer being an electrically isolating substrate layer; a heating element arranged on the first substrate layer; a second substrate layer, the second substrate layer being an electrically isolating substrate layer and being arranged covering the heating element and the first substrate layer; a temperature sensor arranged on the second substrate layer; and at least two electrical contacts configured to contact the temperature sensor, a contact surface of the electrical contacts being configured to contact the temperature sensor is cross-shaped. An aerosol-generating device including the heating assembly is also provided. A method for manufacturing the heating assembly for an aerosol-generating device is also provided.

The present invention relates to a heating assembly for an aerosol-generating device. The invention further relates to an aerosol-generating device and a method for manufacturing a heating assembly.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating assembly may be arranged in or around the heating chamber for heating the aerosol-forming substrate once the aerosol-generating article is inserted into the heating chamber of the aerosol-generating device.

It would be desirable to have a heating assembly for an aerosol-generating device with improved reliability. It would be desirable to have a heating assembly for an aerosol-generating device with improved manufacturing quality. It would be desirable to have a heating assembly for an aerosol-generating device with improved robustness during manufacturing.

According to an embodiment of the invention there is provided a heating assembly for an aerosol-generating device, the heating assembly may comprise a first substrate layer, the first substrate layer may be an electrically isolating substrate layer. The heating assembly may further comprise a heating element. The heating element may be arranged on the first substrate layer. The heating assembly may further comprise a second substrate layer, the second substrate layer may be an electrically isolating substrate layer. The second substrate layer may be arranged covering the heating element and the first substrate layer. The heating assembly may further comprise a temperature sensor. The temperature sensor may be arranged on the second substrate layer. The heating assembly may further comprise at least two electrical contacts for contacting the temperature sensor. The contact surface of the electrical contacts contacting the temperature sensor may be cross-shaped.

According to an embodiment of the invention there is provided a heating assembly for an aerosol-generating device, the heating assembly comprising a first substrate layer, the first substrate layer being an electrically isolating substrate layer. The heating assembly further comprises a heating element. The heating element is arranged on the first substrate layer. The heating assembly further comprises a second substrate layer, the second substrate layer being an electrically isolating substrate layer. The second substrate layer is arranged covering the heating element and the first substrate layer. The heating assembly further comprises a temperature sensor. The temperature sensor is arranged on the second substrate layer. The heating assembly further comprises at least two electrical contacts for contacting the temperature sensor. The contact surface of the electrical contacts contacting the temperature sensor is cross-shaped.

The cross-shaped contact surface of the electrical contacts contacting the temperature sensor improves the mechanical stability of the electrical contact between the temperature sensor and the electrical contacts. Particularly, during an operation of the heating assembly, one or more elements of the heating assembly may be subjected to thermal expansion. A firm contact between the temperature sensor and the electrical contacts may thus be necessary. This is facilitated by the cross-shaped contact surface. Without being bound to any theory, it is believed that the cross-shaped contact surface increases the mechanical stability in the two dimensions of a two-dimensional plane of the contact surface.

The cross-shaped contact surface of the electrical contacts contacting the temperature sensor preferably means that each of the electrical contacts of the temperature sensor comprises a first conductive elongate component and a second conductive elongated component arranged transversally with respect to said first conductive elongate component. The first conductive elongate component may intersect with the second conductive elongate component in the center of the respective electrical contact. A central portion of the first conductive elongate component may intersect with a central portion of the second conductive elongate component. A longitudinal axis of the first conductive elongate component may be perpendicular to a longitudinal axis of the second conductive elongate component. The length of the first conductive elongate component, measured along the longitudinal axis of the first conductive element component, may be larger than the width of the first conductive elongate component. The length may be larger than the width by a factor of two, preferably by a factor of three, more preferably by a factor of four, most preferably by a factor of five. Similarly, the length of the second conductive elongate component, measured along the longitudinal axis of the second conductive element component, may be larger than the width of the second conductive elongate component. The length may be larger than the width by a factor of two, preferably by a factor of three, more preferably by a factor of four, most preferably by a factor of five.

The term ‘covering’ or ‘cover’ may mean that a first layer has the substantial same surface size as a second layer so that the first layer can be placed on the second layer in a way that the surface area of the second layer facing the first layer is substantially overlapped by the first layer. In case a first layer is arranged covering a second layer, the surface size of the first layer may be at least 90% of the surface area of the second layer, preferably the surface size of the first layer may be at least 80% of the surface area of the second layer, more preferably the surface size of the first layer may be at least 70% of the surface area of the second layer, most preferably the surface size of the first layer may be at least 60% of the surface area of the second layer

The heating element may be sandwiched between the first substrate layer and the second substrate layer. The heating element may only cover a portion of the surface of the first substrate layer. When the second substrate layer is placed on the first substrate layer and on the heating element, the second substrate layer preferably covers the heating element and covers the rest of the surface of the first substrate layer on which the heating element is arranged and that is not covered by the heating element.

The heating assembly may further comprise a third substrate layer, the third substrate layer may be an electrically isolating substrate layer. The third substrate layer may be arranged at least partly covering the temperature sensor and covering the second substrate layer.

Similarly, the temperature sensor may be sandwiched between the second substrate layer and a third substrate layer. The temperature sensor may only cover a portion of the surface of the second substrate layer. When the third substrate layer is placed on the second substrate layer and on the temperature sensor, the third substrate layer preferably covers the temperature sensor and covers the rest of the surface of the second substrate layer on which the temperature sensor is arranged and that is not covered by the temperature sensor.

In the final heating assembly, the heating element and the temperature sensor are preferably arranged on opposite surfaces of the second substrate layer. Hence, the heating element is electrically isolated from the temperature sensor via the second substrate layer.

The heating element is protected by the first substrate layer and by the second substrate layer.

The temperature sensor is protected by the second substrate layer and by the third substrate layer.

The heating element may be a resistive heater. The heating element may comprise a heating track. The heating element may be a heating track. The heating tracks may be configured to generate heat. The heating tracks may be electrically resistive heating tracks. The heating elements may comprise electrical contacts for electrically contacting the heating tracks. The electrical contacts may be attached to the heating tracks by any known means, exemplarily by soldering or welding. A first electrical contact may be attached to a first end of the heating tracks and a second electrical contact may be attached to a second end of the heating tracks. The first end of the heating tracks may be a proximal end of the heating tracks and the second end of the heating tracks may be a distal end of the heating tracks or vice versa.

The heating tracks may be made from stainless-steel. The heating tracks may be made from stainless-steel at about 50 μm thickness. The heating tracks may be preferably made from stainless-steel at about 25 μm thickness. The heating tracks may be made from inconel at about 50.8 μm thickness. The heating tracks may be made from inconel at about 25.4 μm thickness. The heating tracks may be made from copper at about 35 μm thickness. The heating tracks may be made from constantan at about 25 μm thickness. The heating tracks may be made from nickel at about 12 μm thickness. The heating tracks may be made from brass at about 25 μm thickness.

The heating element, preferably the heating tracks, may be printed on the first substrate layer. The heating tracks may be photo-printed on the substrate layer. The heating tracks may be chemically etched on the substrate layer.

The term ‘heating tracks’ encompasses a single heating track. The heating element or the heating tracks may be printed on the first substrate layer.

The heating tracks may be centrally arranged on the first substrate layer. The heating tracks may have a bent shape. The heating tracks may have a curved shape. The heating tracks may have a zigzag shape. This heating tracks may have a winding shape.

The heating assembly may be rolled into a tube. The heating tracks may be flat before the substrate layer is rolled into the tubular shape. The heating tracks or the heating element may be flexible. The heating tracks or the heating element may conform to the tubular shape of the substrate layer when the substrate layer is rolled into the tubular shape.

The third substrate layer may comprise at least two openings. The two openings are provided for enabling the electrical contacts of the temperature sensor to be contacted through the third substrate layer.

The two openings may be aligned such that the two contacts are not covered by the third substrate layer. The two openings may be arranged adjacent to opposite ends of the third substrate layer. The two openings may correspond to the placement of electrical contacts on the temperature sensor.

In addition to the two openings, a further opening may be provided in the third substrate layer. The third opening may be arranged centrally in the third substrate layer. This third opening may increase the mechanical strength of the third substrate layer in this area. Particularly, the opening in the middle of the third substrate layer may strengthen the fixation of the electrical wires contacting the electrical contacts of the temperature sensor, since the electrical wires come into contact with the underlying adhesive layer of the second substrate layer in this area.

The electrical contacts of the temperature sensor may be attached to the temperature sensor by any known means, exemplarily by soldering or welding. A first electrical contact may be attached to a first end of the temperature sensor and a second electrical contact may be attached to a second end of the temperature sensor. The first end of the temperature sensor may be a proximal end of the temperature sensor and the second end of the temperature sensor may be a distal end of the temperature sensor or vice versa.

The temperature sensor may comprise temperature sensor tracks.

The heating assembly may comprise a tube, preferably a metal tube, around which the substrate layer may be wrapped or rolled. The metal tube is preferable a stainless-steel tube. Alternatively, the tube may be a ceramic tube. The tube may define the tubular shape of the heating assembly. The outer diameter of the tube may correspond to the inner diameter of the first substrate layer after rolling of the heating assembly.

The heating assembly may further comprise a heating chamber conformed by the tubular shape of the heating assembly. The substrate layers together with the heating element and the temperature sensor may be rolled to conform the tube forming the heating chamber. In this configuration, the first substrate layer may form the inner layer facing the tube and the third substrate layer may be the outer layer. The first substrate layer may be adjacent the metal tube forming the innermost layer of the heating assembly.

The tube may be made from stainless-steel. The tube may have a length of between 10 mm and 35 mm, preferably between 12 mm and 30 mm, preferably between 13 mm and 22 mm. The tube may be a hollow tube. The hollow tube may have an internal diameter of between 4 mm and 9 mm, preferably between 5 mm and 6 mm or between 6.8 mm and 7.5 mm, preferably around 5.35 mm or around 7.3 mm. The tube may have a thickness of between 70 μm and 110 μm, preferably between 80 μm and 100 μm, preferably around 90 μm. The tube may have a cylindrical cross-section. The tube may have a circular cross-section.

The length of the first substrate layer may be equal to or less than the circumference of the tube. The first substrate layer may fully wrap around the tube. The first substrate layer may wrap around the tube once such that the surface of the tube is covered by the first substrate layer after the first substrate layer has been wrapped around the tube.

The tube of the heating chamber may have a thickness of between 70 μm and 110 μm, preferably between 80 μm and 100 μm, preferably around 90 μm.

The temperature sensor may be an NTC, a Pt100 or preferably a Pt1000 temperature sensor. The temperature sensor may be attached to the second substrate layer by means of an adhesive layer. The temperature sensor may be photo-printed onto the second substrate layer. Chemical etching may be utilized for forming one or both of the heating tracks of the heating element and the temperature sensor tracks. Subsequently, the contacts of the temperature sensor may be welded on the temperature sensor tracks through the openings in the third substrate layer.

The temperature sensor may be positioned on the second substrate layer such that when the heating assembly is rolled up, the temperature sensor may be positioned in an area corresponding to the centre of the first substrate layer. By positioning the temperature sensor in this way, the heating element may be mapping the temperature sensor so that the temperature sensor is positioned adjacent the hottest part of the heating element. The hottest part adjacent the temperature sensor may be the centre of the first substrate layer. The heating element may be arranged at the center of the first substrate layer. The temperature sensor may be arranged directly adjacent the heating element only distanced from the heating element by the thickness of the second substrate layer.

One or more of the following additional layers may be provided:

a first adhesive layer may be provided between the first substrate layer and the heating element,

a second adhesive layer may be provided between the heating element and the second substrate layer,

a third adhesive layer may be provided between the second adhesive layer and the temperature sensor, and

a fourth adhesive layer may be provided between the temperature sensor and the third substrate layer.

The first adhesive layer may facilitate attachment between the first substrate layer and the heating element. The first adhesive layer may further facilitate attachment between the first substrate layer and the second substrate layer in the area of the first substrate layer not covered by the heating element. The second adhesive layer may facilitate attachment between the heating element and the second substrate layer. The third adhesive layer may facilitate attachment between the second substrate layer and the temperature sensor. The third adhesive layer may further facilitate attachment between the second substrate layer and the third substrate layer in the area of the third adhesive layer not covered by the temperature sensor. The fourth adhesive layer may facilitate attachment between the temperature sensor and the third substrate layer.

One or more of the adhesive layers may have a thickness of between 2 μm and 10 μm, preferably between 3 μm and 7 μm, more preferably around 5 μm.

One or more of the adhesive layers may be a silicon-based adhesive layer. The adhesive layer may comprise one or both of PEEK-based adhesives and acrylic adhesives.

One or more of the first substrate layer, the second substrate layer and the third substrate layer may comprise a polyamide or polyimide film. Any of the substrate layers may be made from polyimide or polyamide. The substrate layers may be configured to withstand between 220° C. and 320° C., preferably between 240° C. and 300° C., preferably around 280° C. Any of the substrate layers may be made from Pyralux.

A heat shrink layer may be arranged around the heating assembly.

The heat shrink layer may be arranged around the heating assembly when the heating assembly is rolled into the tubular shape. The heat shrink layer may be configured to shrink when heated. The heat shrink layer may securely hold the heating assembly together. The heat shrink layer may be configured to apply a uniform inwards pressure to the heating assembly. The heat shrink layer may improve the contact between one or both of the tube and the first substrate layer and the second substrate layer and the third substrate layer. The heat shrink layer may hold most or all components of the heating assembly tight together. The heat shrink layer may be employed to replace the glue layers or adhesive layers described herein. Alternatively, the heat shrink layer may be employed in addition to the glue layers or adhesive layers described herein.

The thickness of the heat shrink layer may be between 100 μm and 300 μm, preferably around 180 μm.

The heat shrink layer may be made of PEEK. The heat shrink layer may be made of or comprise one or more of Teflon and PTFE.

One or more of the substrate layers may have a thickness of between 10 μm and 50 μm, preferably between 20 μm and 30 μm, more preferably around 25 μm.

The heating element may, when preferably made of stainless-steel, have a thickness of between 20 μm and 60 μm, preferably between 30 μm and 50 μm, more preferably around 40 μm.

The heating tracks may, when preferably made of stainless-steel, have a thickness of between 20 μm and 60 μm, preferably between 30 μm and 50 μm, more preferably around 40 μm.

Surrounding the heat shrink layer, a thermally insulating layer may be provided. The thermal insulating layer is preferably made of aerogel.

The invention further relates to an aerosol-generating device comprising the heating assembly as described herein.

The aerosol-generating device may comprise a cavity for receiving an aerosol-generating article. The heating assembly may be arranged at least partly surrounding the cavity.

A sidewall of the cavity may be formed of the tube described herein, preferably a stainless-steel tube. The heating assembly may be mounted on the stainless-steel tube or the tube may be part of the heating assembly and mounted within the housing or an inner frame of the aerosol-generating device.

The invention further relates to a method for manufacturing a heating assembly for an aerosol-generating device, the method may comprise one or more of the following steps:

providing a first substrate layer, the first substrate layer being an electrically isolating substrate layer,

arranging a heating element on the first substrate layer,

arranging a second substrate layer covering the heating element and the first substrate layer, the second substrate layer being an electrically isolating substrate layer,

arranging a temperature sensor on the second substrate layer,

electrically contacting the temperature sensor with at least two electrical contacts, wherein the contact surface of the electrical contacts contacting the temperature sensor is cross-shaped.

The invention further relates to a method for manufacturing a heating assembly for an aerosol-generating device, the method comprising the steps of:

providing a first substrate layer, the first substrate layer being an electrically isolating substrate layer,

arranging a heating element on the first substrate layer,

arranging a second substrate layer covering the heating element and the first substrate layer, the second substrate layer being an electrically isolating substrate layer,

arranging a temperature sensor on the second substrate layer,

electrically contacting the temperature sensor with at least two electrical contacts, wherein the contact surface of the electrical contacts contacting the temperature sensor is cross-shaped.

As used herein, the terms “upstream” and “downstream”, are used to describe the relative positions of components, or portions of components, of the aerosol generating device in relation to the direction in which airflows through the aerosol generating device during use thereof. Aerosol generating devices according to the invention comprise a proximal end through which, in use, an aerosol exits the device. The proximal end of the aerosol generating device may also be referred to as the mouth end or the downstream end. The mouth end is downstream of the distal end. The distal end of the aerosol generating article may also be referred to as the upstream end. Components, or portions of components, of the aerosol generating device may be described as being upstream or downstream of one another based on their relative positions with respect to the airflow path of the aerosol generating device.

In all of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics.

As described, in any of the aspects of the disclosure, the heating element may comprise an external heating element, where “external” refers to the aerosol-forming substrate. An external heating element may take any suitable form. For example, an external heating element may take the form of one or more flexible heating foils or heating tracks on a dielectric substrate, such as polyimide. The dielectric substrate is the substrate layer. The flexible heating foils or heating tracks can be shaped to conform to the perimeter of the heating chamber. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on the suitable shaped substrate layer. An external heating element may also be formed using a metal having a defined relationship between temperature and resistivity. In such an exemplary device, the metal may be formed as a track between the first substrate layer and the second substrate layer. An external heating element formed in this manner may be used to both heat and monitor the temperature of the external heating element during operation.

The heating element advantageously heats the aerosol-forming substrate by means of conduction. Alternatively, the heat from either an internal or external heating element may be conducted to the substrate by means of a heat conductive element.

During operation, the aerosol-forming substrate may be completely contained within the aerosol-generating device. In that case, a user may puff on a mouthpiece of the aerosol-generating device. Alternatively, during operation a smoking article containing the aerosol-forming substrate may be partially contained within the aerosol-generating device. In that case, the user may puff directly on the smoking article.

The heating element may be configured as an induction heating element. The induction heating element may comprise an induction coil and a susceptor. In general, a susceptor is a material that is capable of generating heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate. When an induction heating element is employed, the induction heating element may be configured as an external heater as described herein. If the induction heating element is configured as an external heating element, the susceptor element is preferably configured as a cylindrical susceptor at least partly surrounding the heating chamber. The heating tracks described herein may be configured as a susceptor. The susceptor may be arranged between the first substrate layer and the second substrate layer. The first substrate layer may be surrounded by the induction coil. The susceptor as well as the induction coil may be part of the heating assembly.

Preferably, the aerosol-generating device comprises a power supply configured to supply power to the one or both of the heating element and the heating assembly. The power supply preferably comprises a power source. Preferably, the power source is a battery, such as a lithium ion battery. As an alternative, the power source may be another form of charge storage device such as a capacitor. The power source may require recharging. For example, the power source may have sufficient capacity to allow for the continuous generation of aerosol for a period of around six minutes or for a period that is a multiple of six minutes. In another example, the power source may have sufficient capacity to allow for a predetermined number of puffs or discrete activations of the heating assembly.

The aerosol-generating device may comprise control electronics. The control electronics may comprise a microcontroller. The microcontroller is preferably a programmable microcontroller. The electric circuitry may comprise further electronic components. The electric circuitry may be configured to regulate a supply of power to the heating assembly. Power may be supplied to the heating assembly continuously following activation of the system or may be supplied intermittently, such as on a puff-by-puff basis. The power may be supplied to the heating assembly in the form of pulses of electrical current.

The control electronics may comprise a printed circuit board. The control electronics may be configured as a printed circuit board.

The temperature sensor may be electrically connected with the control electronics. The length of the electrical connections between the temperature sensor and the control electronics may be longer than the distance between the temperature sensor and the control electronics. This may have the beneficial effect of preventing a detrimental effect on the electrical contact between the temperature sensor and the control electronics due to thermal expansion of the contacts during operation of the aerosol-generating device. The electrical connections are preferably configured as electrical wires.

Similarly, the length of the electrical connections between the heating element and the control electronics may be longer than the distance between the heating element and the control electronics. This may have the beneficial effect of preventing a detrimental effect on the electrical contact between the heating element and the control electronics due to thermal expansion of the contacts during operation of the aerosol-generating device. The electrical connections are preferably configured as electrical wires.

As used herein, the term “aerosol-forming substrate” refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or liquid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. An aerosol-generating article may be disposable.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomiser, such as an electric heater, to heat the aerosol-forming substrate to form an aerosol.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

Features described in relation to one embodiment may equally be applied to other embodiments of the invention.

The invention will be further described, by way of example only, with reference to the accompanying drawings in which:

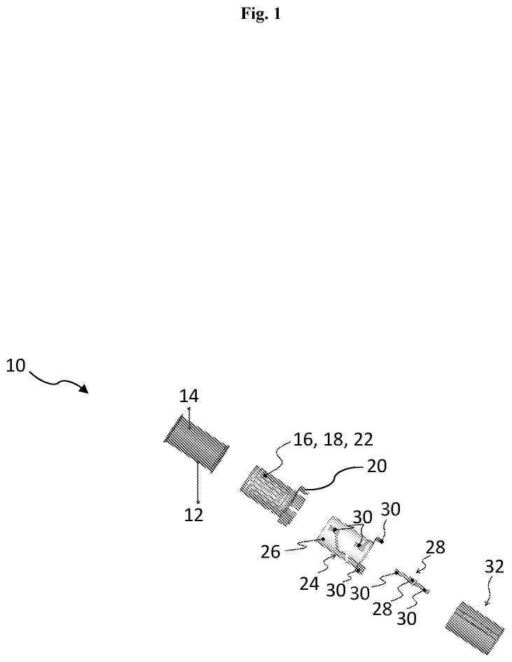

FIG. 1 shows the heating assembly;

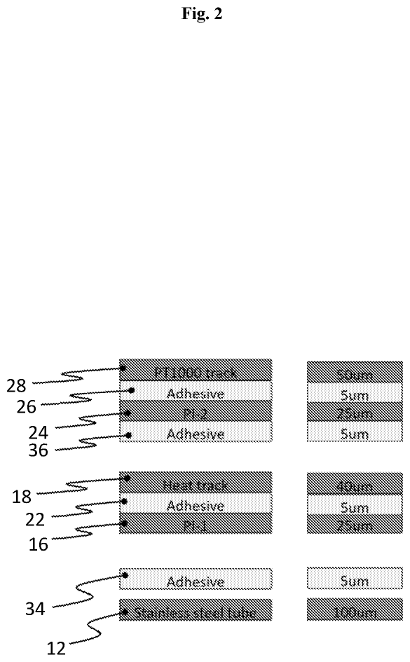

FIG. 2 shows layers making up the heating assembly;

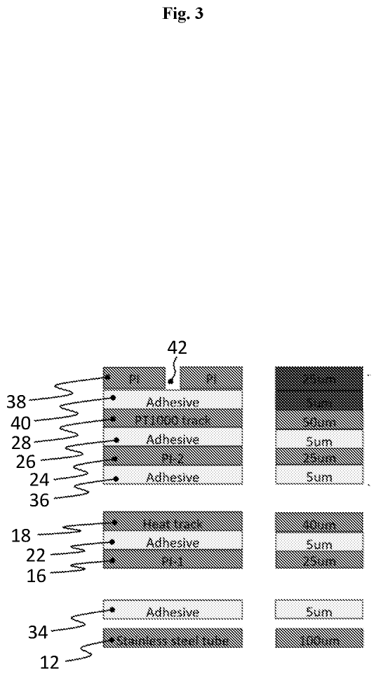

FIG. 3 shows layers making up the heating assembly including a third insulating layer; and

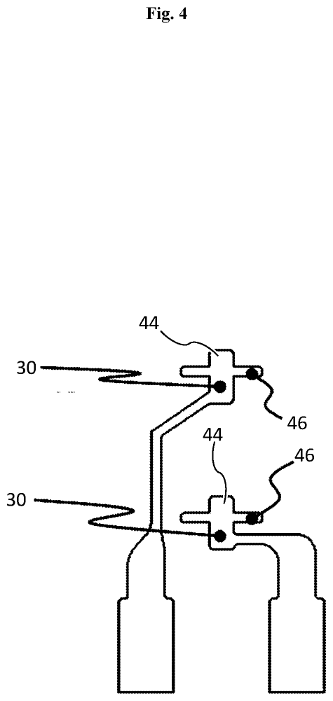

FIG. 4 shows details about the contacts of the temperature sensor.

FIG. 1 shows a heating assembly 10. The heating assembly 10 comprises a stainless-steel tube 12. The stainless-steel tube 12 forms the inner layer of the heating assembly 10. The stainless-steel tube 12s tubular. The stainless-steel tube 12 forms a heating chamber 14 such that an aerosol-generating article comprising aerosol forming substrate can be placed in the heating chamber 14 to heat the aerosol-forming substrate and to create an inhalable aerosol.

FIG. 1 further shows a first substrate layer 16. On top of the first substrate layer 16, a heating element 18 in the form of heating tracks is arranged. Electrical heater contacts 20 of the heating element 18 also indicated in FIG. 1. On the first substrate layer 16, a first adhesive layer 22 is arranged for an attachment between the first substrate layer 16 and the heating element 18. Additionally, the surface area of the first substrate layer 16 not covered with the heating element 18 may be attached to the second substrate layer 24 via the first adhesive layer 22.

FIG. 1 further shows the second substrate layer 24. On the second substrate layer 24, a second adhesive layer 26 is arranged. The second adhesive layer 26 has the function of enabling an attachment between the second substrate layer 24 and a temperature sensor 28. The second adhesive layer 26 further facilitates the attachment between the second substrate layer 24 and sensor contacts 30 of the temperature sensor 28. Finally, the second adhesive layer 26 facilitates the attachment between the second substrate layer 24 and a third substrate layer 38. The third substrate layer 38 is arranged over the temperature sensor 28 as described in more detail below with reference to FIG. 3. The third substrate layer 38 is not depicted in FIG. 1. Finally, a heat shrink layer 32 is placed over the heating assembly 10. Heating of the heat shrink layer 32 facilitates a secure holding of all components of the heating assembly 10.

FIG. 2 shows the layers of the heating assembly 10 in more detail. The inner layers formed by the stainless-steel tube 12. A tube adhesive layer 34 is utilized to connect the stainless-steel tube 12 with the first substrate layer 16. As a next layer, the heating element 18 is arranged on the first substrate layer 16 versus the first adhesive layer 22. Between the heating element 18 and the second substrate layer 24, a heater adhesive layer 36 is arranged. Finally, the temperature sensor 28 is arranged on the second substrate layer 24 via the second adhesive layer 26.

FIG. 2 further shows the preferred thicknesses of all layers.

FIG. 3 shows the additional placement of a third substrate layer 38 over the temperature sensor 28 via a sensor adhesive layer 40. In the third substrate layer 38 at least two openings 42 are provided to enable sensor contacts 30 to be contacted through the third substrate layer 38.

FIG. 3 further shows the preferred thicknesses of all layers.

FIG. 4 shows the specific configuration of the sensor contacts 30. Particularly, the contact surface between the sensor contacts 30 and the temperature sensor 28 are shown in FIG. 4. The contact surfaces of the individual sensor contacts 28 are cross-shaped. This improves the mechanical strength of these contact surfaces such that the electrical contact between the temperature sensor and the sensor contacts is improved.

To generate the cross-shape of the contact surfaces of the sensor contacts 30, each individual sensor contacts 30 is provided with a first conductive element component 44, which is elongate. Transversally to this first conductive element component 44, a second conductive element component 46 is provided. The second conductive element component 46 is also elongate. The first conductive element component 44 is intersecting the second conductive element component 46 to create the cross-shape of the individual sensor contact 30.

1.-15. (canceled)

16. A heating assembly for an aerosol-generating device, the heating assembly comprising:
a first substrate layer, the first substrate layer being an electrically isolating substrate layer;
a heating element arranged on the first substrate layer;
a second substrate layer, the second substrate layer being an electrically isolating substrate layer, wherein the second substrate layer is arranged covering the heating element and the first substrate layer;
a temperature sensor arranged on the second substrate layer; and
at least two electrical contacts configured to contact the temperature sensor,
wherein a contact surface of the electrical contacts configured to contact the temperature sensor is cross-shaped.

17. The heating assembly according to claim 16, further comprising a third substrate layer, the third substrate layer being an electrically isolating substrate layer, wherein the third substrate layer is arranged at least partly covering the temperature sensor and covering the second substrate layer.

18. The heating assembly according to claim 17, wherein the third substrate layer comprises at least two openings.

19. The heating assembly according to claim 18, wherein the at least two openings are aligned such that the at least two contacts are not covered by the third substrate layer.

20. The heating assembly according to claim 16, wherein the heating element is a resistive heater.

21. The heating assembly according to claim 16, wherein the heating element comprises a heating track.

22. The heating assembly according to claim 16, wherein the heating element is printed on the first substrate layer.

23. The heating assembly according to claim 16, wherein the heating assembly is rolled into a tube.

24. The heating assembly according to claim 16, wherein a heat shrink layer is arranged around the heating assembly.

25. The heating assembly according to claim 24, wherein the heat shrink layer is made of PEEK.

26. The heating assembly according to claim 17,
wherein a heat shrink layer is arranged around the heating assembly, and
wherein one or more of:
a first adhesive layer is provided between the first substrate layer and the heating element,
a second adhesive layer is provided between the heating element and the second substrate layer,
a third adhesive layer is provided between the second adhesive layer and the temperature sensor, and
a fourth adhesive layer is provided between the temperature sensor and the third substrate layer.

27. The heating assembly according to claim 17, wherein one or more of the first substrate layer, the second substrate layer, and the third substrate layer comprise a polyamide film.

28. An aerosol-generating device comprising the heating assembly according to claim 16.

29. The aerosol-generating device according to claim 28,
wherein the aerosol-generating device comprises a cavity configured to receive an aerosol-generating article, and
wherein the heating assembly is arranged at least partly surrounding the cavity.

30. The aerosol-generating device according to claim 29,
wherein a sidewall of the cavity is formed of a stainless-steel tube, and
wherein the heating assembly is mounted on the stainless-steel tube.

31. A method for manufacturing a heating assembly for an aerosol-generating device, the method comprising the steps of:
providing a first substrate layer, the first substrate layer being an electrically isolating substrate layer;
arranging a heating element on the first substrate layer;
arranging a second substrate layer covering the heating element and the first substrate layer, the second substrate layer being an electrically isolating substrate layer;
arranging a temperature sensor on the second substrate layer;
electrically contacting the temperature sensor with at least two electrical contacts, wherein a contact surface of the electrical contacts contacting the temperature sensor is cross-shaped.
